(19) United States
(12) Patent Application Publication
(10) Pub. No.: US 2023/0286069 A1
(43) Pub. Date: Sep. 14, 2023

(54) BLADE SHARPENER FOR OSCILLATING MULTI-TOOL SAWBLADES

(71) Applicants: Russell Lee Roark, Colfax, CA (US); Brent Neal Ostrom, Colfax, CA (US)

(72) Inventors: Russell Lee Roark, Colfax, CA (US); Brent Neal Ostrom, Colfax, CA (US)

(21) Appl. No.: 17/690,566

(22) Filed: Mar. 9, 2022

(51) Int. Cl. B23D 63/10

(52) U.S. Cl. CPC B23D 63/10

(57) ABSTRACT

An apparatus and methods are provided for a sawblade sharpener for extending the operating life of oscillating multi-tool sawblades. The sawblade sharpener comprises a first blade that includes a multiplicity of cutting teeth. A second blade is pivotally coupled with the second blade and includes a multiplicity of cutting teeth. The cutting teeth are configured to shear off a dulled cutting edge from the sawblade and form a new cutting edge, thereby providing a sharpened sawblade. The cutting teeth may have a size and shape suitable for forming any of course cutting teeth, medium cutting teeth, fine cutting teeth, or very fine cutting teeth, and the like. The sawblade sharpener may be operated by hand, such as by squeezing handles coupled with the first and second blades or may be configured to be mounted onto a tabletop or workbench and operated by way of a lever.

### FIELD

Embodiments of the present disclosure generally relate to oscillating-saw blades. More specifically, embodiments of the disclosure relate to an apparatus and methods for a sawblade sharpener for extending the operating life of oscillating multi-tool sawblades.

### BACKGROUND

An oscillating multi-tool is a compact, portable power tool that accepts a wide range of interchangeable blades that can be used to sand, cut, scrape, grind, and polish. During operation, the blade oscillates side-to-side at very high speeds, making the oscillating multi-tool much easier and safer to use than other types of saws, such as circular saws, reciprocating saws, jigsaws, and the like. Oscillating multi-tool saws are increasingly popular since they can cut through a variety of building materials, including wood, metal, drywall, cement, mortar, plastic, fiberglass, and the like. Further, oscillating multi-tools are particularly suitable for working in locations that cannot be accessed by other power tools, such as narrow spaces, tight interior corners, awkward angles, and the like.

FIG. 1 illustrates an exemplary embodiment of a prior art sawblade 100 that is configured for use with an oscillating multi-tool. The sawblade 100 comprises a sawblade body 104 that may be configured in a plate-shaped manner with an approximately rectangular geometry. In some instances, the sawblade body 104 may have a slightly trapezoidal geometry. A fastening portion 108 of the sawblade 100 is configured to enable coupling the sawblade 100 to a tool shaft (not shown) comprising the oscillating multi-tool. The fastening portion 108 may comprise a substantially disk-shaped member that includes a fastening cutout 112 for receiving the tool shaft. A multiplicity of latching openings 116 may be arranged around the fastening cutout 112 and configured to receive latching protuberances of the oscillating multi-tool so as to transmit torque from the tool shaft to the sawblade 100. A front edge of the sawblade body 104, remote from the fastening portion 108, is configured as a cutting edge 120 having a multiplicity of cutting teeth.

During operation, the oscillating multi-tool transmits a side-to-side torque to the sawblade 100, causing the cutting edge 120 to move side-to-side in a manner suitable for cutting a wide variety of materials. A drawback to the sawblade 100, however, is that the cutting edge 120 can become quickly dulled, sometimes within a matter of seconds, thereby necessitating replacement with a newer, sharper sawblade 100. Although dulled sawblades 100 can be sharpened by hand or by grinding, such methods are tedious, time consuming, and typically fail to restore the sawblade 100 to a suitably sharp cutting edge 120. As such, sawblades 100 for oscillating multi-tools generally are considered to be a single-use item that is discarded once the cutting edges 120 have dulled.

What is needed, therefore, is a blade sharpener for oscillating multi-tool sawblades that can be used to restore sawblades having dulled cutting edges, thereby extending the operating life of oscillating multi-tool sawblades.

### SUMMARY

An apparatus and methods are provided for a sawblade sharpener for extending the operating life of oscillating multi-tool sawblades. The sawblade sharpener comprises a first blade that includes a multiplicity of cutting teeth. A second blade is pivotally coupled with the second blade and includes a multiplicity of cutting teeth. The cutting teeth are configured to shear off a dulled cutting edge from the sawblade and form a new cutting edge, thereby providing a sharpened sawblade. The cutting teeth may have a size and shape suitable for forming any of course cutting teeth, medium cutting teeth, fine cutting teeth, or very fine cutting teeth, and the like. The sawblade sharpener may be operated by hand, such as by squeezing handles coupled with the first and second blades or may be configured to be mounted onto a tabletop or workbench and operated by way of a lever.

In an exemplary embodiment, a sawblade sharpener for forming a new cutting edge on an oscillating multi-tool sawblade comprises: a first blade including a first multiplicity of cutting teeth; a second blade including a second multiplicity of cutting teeth and pivotally coupled with the first blade; a first handle coupled with the first blade; a second handle coupled with the second blade; a handle pivot for engaging the first multiplicity of cutting teeth with the second multiplicity of cutting teeth so as to form the new cutting edge; and a spring mounted on the handle pivot for biasing the first handle and the second handle in an open configuration.

In another exemplary embodiment, the first multiplicity of cutting teeth and the second multiplicity of cutting teeth have a size and configuration suitable for forming the new cutting edge. In another exemplary embodiment, the configuration comprises a zigzag shape. In another exemplary embodiment, the size is suitable for forming any of course cutting teeth, medium cutting teeth, fine cutting teeth, or very fine cutting teeth.

In another exemplary embodiment, the first handle and the second handle are configured such that squeezing the first handle and the second handle together causes the first blade and the second blade to move toward one another. In another exemplary embodiment, the first blade is coupled with the first handle by way of a first handle fastener; and wherein the second blade is coupled with the second handle by way of a second handle fastener. In another exemplary embodiment, the first blade and the second blade are coupled together by way of a blade pivot. In another exemplary embodiment, the first multiplicity of cutting teeth and the second multiplicity of cutting teeth are configured to cooperate with one another for the purpose of forming the new cutting edge the first handle and the second handle are squeezed toward one another. In another exemplary embodiment, the first multiplicity of cutting teeth and the second multiplicity of cutting teeth are configured to shear off a dulled cutting edge so as to form the new cutting edge.

In an exemplary embodiment, a sawblade sharpener for forming a new cutting edge on an oscillating multi-tool sawblade comprises: a first blade including a first multiplicity of cutting teeth; a second blade including a second multiplicity of cutting teeth and pivotally coupled with the first blade; a vertical portion for supporting the first blade; a base portion for supporting the second blade; a lever coupled with the vertical portion for engaging the first multiplicity of cutting teeth with the second multiplicity of cutting teeth so as to form the new cutting edge; and a mechanism for supporting the oscillating multi-tool sawblade between the first blade and the second blade.

In another exemplary embodiment, the first multiplicity of cutting teeth and the second multiplicity of cutting teeth have a size and configuration suitable for forming the new cutting edge. In another exemplary embodiment, the configuration comprises a zigzag shape. In another exemplary embodiment, the size is suitable for forming any of course cutting teeth, medium cutting teeth, fine cutting teeth, or very fine cutting teeth.

In another exemplary embodiment, the base portion is configured to be coupled with a horizontal surface such as tabletop or a workbench. In another exemplary embodiment, a forcible lever couples the first blade with the lever, such that a downward force is transmitted to the first blade when the lever is rotated relative to the vertical portion.

In an exemplary embodiment, a method for sharpening an oscillating multi-tool sawblade by way of a sawblade sharpener comprises: supporting the oscillating multi-tool sawblade between a first blade and a second blade; causing the first blade to move toward the second blade; and shearing off a dulled cutting edge of the oscillating multi-tool sawblade.

In another exemplary embodiment, the supporting comprises using a magnet to support the oscillating multi-tool sawblade such that the dulled cutting edge is disposed between the first blade and the second blade. In another exemplary embodiment, causing the first blade to move comprises using a lever to engage a first multiplicity of cutting teeth comprising the first blade with a second multiplicity of cutting teeth comprising the second blade. In another exemplary embodiment, shearing off the dulled cutting edge includes forming a new cutting edge. In another exemplary embodiment, forming the new cutting edge includes cutting the oscillating multi-tool sawblade by way of the first multiplicity of cutting teeth and the second multiplicity of cutting teeth.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an exemplary embodiment of a prior art sawblade that is configured for use with an oscillating multi-tool;

FIG. 2 illustrates a perspective view of an exemplary embodiment of a handheld sawblade sharpener for restoring sawblades having dulled cutting edges in accordance with the present disclosure; and

FIG. 3 illustrates a perspective view of an exemplary embodiment of sawblade sharpener that may be mounted to a tabletop or workbench for restoring sawblades having dulled cutting edges, according to the present disclosure.

While the present disclosure is subject to various modifications and alternative forms, specific embodiments thereof have been shown by way of example in the drawings and will herein be described in detail. The sawblade sharpener presented herein should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the blade sharpeners disclosed herein may be practiced without these specific details. In other instances, specific numeric references such as “first sawblade,” may be made. However, the specific numeric reference should not be interpreted as a literal sequential order but rather interpreted that the “first sawblade” is different than a “second sawblade.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Oscillating multi-tool saws are increasingly popular since they can cut through virtually any building material and are particularly suitable for working locations that cannot be accessed by other power tools. A drawback to sawblades used with oscillating multi-tools, however, is that the cutting edge of the sawblade can become quickly dulled, sometimes within a matter of seconds, thereby necessitating replacement with a newer, sharper sawblade. Although dulled sawblades can be sharpened by hand or by grinding, such methods are tedious, time consuming, and typically fail to restore the sawblade to a suitably sharp cutting edge. As such, sawblades for oscillating multi-tools generally are considered to be a single-use item that is discarded once the cutting edges have dulled. Embodiments presented herein provide blade sharpeners for oscillating multi-tool sawblades that restore sawblades having dulled cutting edges, thereby extending the operating life of oscillating multi-tool sawblades.

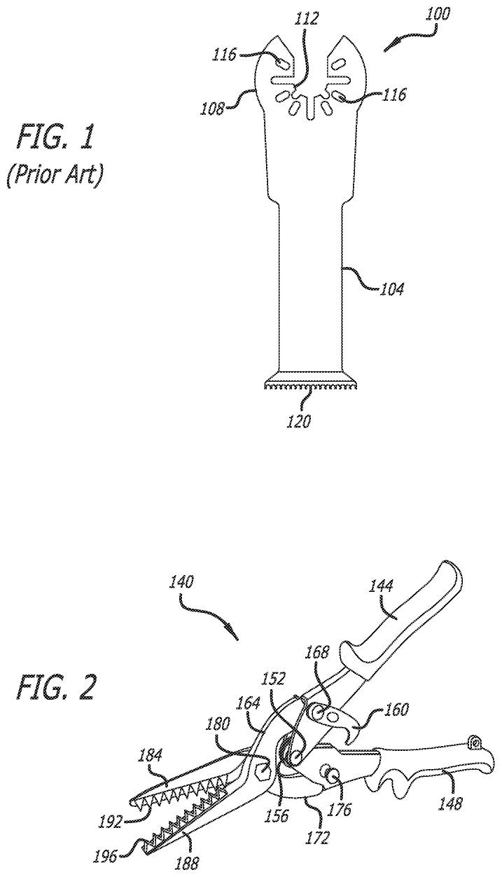

FIG. 2 illustrates a perspective view of an exemplary embodiment of sawblade sharpener 140 for restoring sawblades having dulled cutting edges, such as, for example, the sawblade 100 shown in FIG. 1. As will be appreciated, the sawblade sharpener 140 is similar to a compound aviation/tin snip that is configured to be held in the hand of a practitioner. As such, the sawblade sharpener 140 includes a first handle 144 and a second handle 148 that are configured to be grasped during restoring the sawblade 100. The first and second handles 144, 148 are hingedly coupled together by way of a handle pivot 152 that enables the first and second handles 144, 148 to rotate with respect to one another. A spring 156 mounted on the handle pivot 152 is configured to bias the first and second handles 144, 148 in an open configuration shown in FIG. 2. A latch 160 fastened to the first handle 144 is configured to engage the second handle 148 such that the first and second handles 144, 148 are held in a closed configuration suitable for storage of the sawblade sharpener 140.

As shown in FIG. 2, a first blade 164 is coupled with the first handle 144 by way of a first handle fastener 168. A second blade 172 is coupled with the second handle 148 by way of a second handle fastener 176. The first and second blades 164, 172 are coupled together by way of a blade pivot 180. Distal of the blade pivot 180, the second blade 172 includes a first cutting end 184. Similarly, the first blade 164 includes a second cutting end 188 that is distal of the blade pivot 180. Upon a practitioner moving the first and second handles 144, 148 toward one another, such as by squeezing with a hand, the first and second fasteners 168, 176 and the blade pivot 180 cause the first and second cutting ends 184, 188 to move toward one another. As shown in FIG. 2, a multiplicity of cutting teeth 192 may be disposed along the first cutting end 184 while a multiplicity of similar cutting teeth 196 may be disposed along the second cutting end 188. The multiplicities of cutting teeth 192, 196 preferably are configured to cooperate with one another for the purpose of cutting an object placed between the cutting ends 184, 188.

As will be appreciated, a practitioner may place an object between the cutting ends 184, 188 and then squeeze the handles 144, 148 together to cause the cutting teeth 192, 196 to move toward one another and shear the object. As such, it is contemplated that the cutting teeth 192, 196 may be configured to cut a new cutting edge 120 into a sawblade, such as the sawblade 100 shown in FIG. 1. In general, once the cutting edge 120 has become dulled, the practitioner may position the dulled cutting edge 120 between the first and second cutting ends 184, 188 and then squeeze the first and second handles 144, 148 to cause the cutting teeth 192, 196 to shear off the dulled cutting edge 120 and form a new, sharp cutting edge 120. The cutting teeth 192, 196 generally are configured with a shape to form the new cutting edge 120, such as, by way of example, a zigzag shape. The cutting teeth 192, 196 may be implemented in a variety of configurations suitable for creating different types cutting edges 120. For example, the cutting teeth 192, 196 may be configured to create a cutting edge 120 comprising course teeth, medium teeth, fine teeth, or very fine teeth, without limitation. Further, in some embodiments, the cutting teeth 192, 196 may be adjustable to accommodate different sizes of cutting teeth that may be desired.

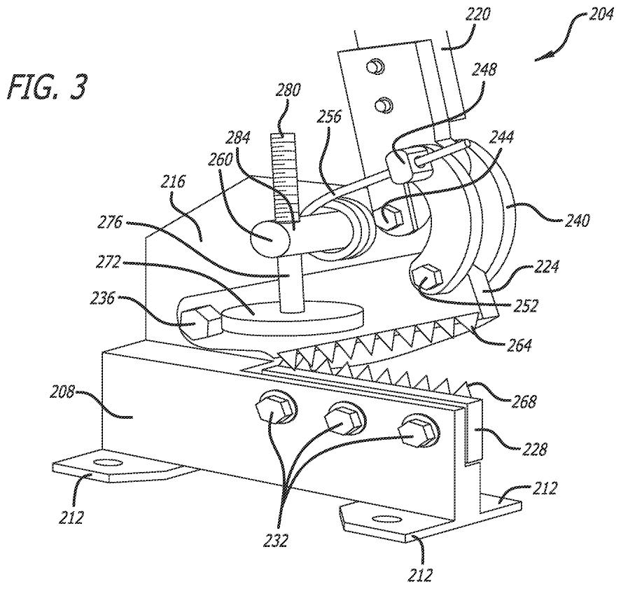

FIG. 3 illustrates a perspective view of an exemplary embodiment of sawblade sharpener 204 for restoring sawblades having dulled cutting edges, such as, for example, the sawblade 100 shown in FIG. 1. The sawblade sharpener 204 is configured to be supported by, or mounted onto, a horizontal surface such as tabletop or a workbench. As such, the sawblade sharpener 204 includes a base portion 208, multiple mounts 212, and a vertical portion 216. The mounts 212 are configured to be fastened to the tabletop or workbench by way of suitable fasteners. The base portion 208 generally is configured to support the sawblade sharpener 204 during restoring a new cutting edge of a sawblade, such as the sawblade 100 shown in FIG. 1.

The vertical portion 216 is fixedly coupled to the base portion 208 and supports a lever 220 that is in mechanical communication with a first blade 224. The first blade 224 is configured to cooperate with a second blade 228 that is fastened to the base portion 208 by way of blade fasteners 232. Thus, the second blade 228 is configured to remain stationary while the first blade 224 is moved with respect to the second blade 228 by way of the lever 220. A blade pivot 236 coupling the first blade 224 with the vertical portion 216 enables the first blade 224 to move relative to the second blade 228.

Opposite of the blade pivot 236, the first blade 224 is coupled with the lever 220 by way of a forcible lever 240. The forcible lever 240 is configured to transmit a downward force to the first blade 224 when the lever 220 is rotated away from the vertical portion 216. As shown in FIG. 3, the vertical portion 216 supports the lever 220 by way of a lever pivot 244 that enables the lever 220 to rotate with respect to the vertical portion 216. The lever 220 is coupled to the forcible lever 240 by way of a first lever pivot 248 while the forcible lever 240 is coupled to the first blade 224 by way of a second lever pivot 252. Thus, a practitioner may rotate the lever 220 away from the vertical portion 216 to cause the first blade 224 to engage with the second blade 228. A spring 256 may be mounted onto a shaft 260 to bias the lever 220 toward the vertical portion 216 and thus to bias the first blade 224 away from the second blade 228.

With continuing reference to FIG. 3, a multiplicity of cutting teeth 264 may be disposed along the first blade 224 while a multiplicity of similar cutting teeth 268 may be disposed along the second blade 228. The multiplicities of cutting teeth 264, 268 preferably are configured to cooperate with one another for the purpose of cutting an object placed between the first and second blades 224, 228.

As will be appreciated, a practitioner may place an object between the first and second blades 224, 228 and then rotate the lever 220 to cause the cutting teeth 264, 268 to move toward one another and shear the object. It is contemplated, therefore, that the cutting teeth 264, 268 may be configured to restore a sawblade having a dulled cutting edge 120, such as the sawblade 100 shown in FIG. 1. For example, once the cutting edge 120 has become dulled, the practitioner may position the cutting edge 120 between the first and second blades 224, 228 and then rotate the lever 220 to cause the cutting teeth 264, 268 to shear off the dulled cutting edge 120 and form a new, sharp cutting edge 120. The cutting teeth 264, 268 generally are configured with a shape suitable for forming a new cutting edge 120, such as, by way of example, the abovementioned zigzag shape. The cutting teeth 264, 268 may be implemented in a variety of configurations suitable for creating different types cutting edges 120. For example, the cutting teeth 264, 268 may be configured to create a cutting edge 120 comprising course teeth, fine teeth, or very fine teeth, without limitation. Further, in some embodiments, the cutting teeth 264, 268 may be adjustable to accommodate different sizes of cutting teeth that may be desired.

Moreover, a mechanism may be incorporated into the vertical portion 216 for supporting the sawblade 100 during sharpening. For example, in the embodiment illustrated in FIG. 3, a magnet 272 is coupled with the vertical portion 216 by way of a shaft 276 that is engaged with the shaft 260. The shaft 276 includes a threaded portion 280 that is threaded into a hole 284 disposed in the shaft 260. As will be appreciated, the threaded portion 280 enables the practitioner to adjust the vertical disposition of the magnet 272 with respect to the first and second blades 224, 228. Thus, it is contemplated that the shaft 276 and the magnet 260 may be adjusted to position the dulled cutting edge 120 of the sawblade 100 just above the second blade 228. The practitioner may then rotate the lever 220 to force the first blade 224 downward onto the dulled cutting edge 120, such that the first and second blades 224, 228 sever the dulled cutting edge 120 from the sawblade 100 and form a new, sharp cutting edge 120, as described herein. Other mechanisms in lieu of the magnet 260 and shaft 276 will be apparent to those skilled in the art without deviating beyond the spirit and scope of the present disclosure.

While the blade sharpeners presented herein have been described in terms of particular variations and illustrative figures, those of ordinary skill in the art will recognize that the blade sharpeners are not limited to the variations or figures described. In addition, where methods and steps described above indicate certain events occurring in certain order, those of ordinary skill in the art will recognize that the ordering of certain steps may be modified and that such modifications are in accordance with the variations of the blade sharpeners. Additionally, certain of the steps may be performed concurrently in a parallel process when possible, as well as performed sequentially as described above. To the extent there are variations of the blade sharpeners, which are within the spirit of the disclosure or equivalent to the blade sharpener found in the claims, it is the intent that this patent will cover those variations as well. Therefore, the present disclosure is to be understood as not limited by the specific embodiments described herein, but only by scope of the appended claims.

1. A sawblade sharpener for forming a new cutting edge on an oscillating multi-tool sawblade, the sharpener comprising:
a first blade including a first multiplicity of cutting teeth;
a second blade including a second multiplicity of cutting teeth and pivotally coupled with the first blade;
a first handle coupled with the first blade;
a second handle coupled with the second blade;
a handle pivot for engaging the first multiplicity of cutting teeth with the second multiplicity of cutting teeth, thereby forming the new cutting edge; and
a spring mounted on the handle pivot for biasing the first handle and the second handle in an open configuration;
a latch fastened to the first handle and configured to engage the second handle so the first and second handles are held in a closed configuration; and
wherein the first multiplicity of cutting teeth and the second multiplicity of cutting teeth are configured to shear off a dulled cutting edge so as to form the new cutting edge.

2. The sharpener of claim 1, wherein the first multiplicity of cutting teeth and the second multiplicity of cutting teeth have a size and configuration suitable for forming the new cutting edge.

3. The sharpener of claim 2, wherein the configuration comprises a zigzag shape.

4. The sharpener of claim 3, wherein the size is suitable for forming one of: course cutting teeth, medium cutting teeth, fine cutting teeth, or very fine cutting teeth.

5. The sharpener of claim 1, wherein the first handle and the second handle are configured such that squeezing the first handle and the second handle together causes the first blade and the second blade to move toward one another.

6. The sharpener of claim 1, wherein the first blade is coupled with the first handle by way of a first handle fastener; and wherein the second blade is coupled with the second handle by way of a second handle fastener.

7. The sharpener of claim 1, wherein the first blade and the second blade are coupled together by way of a blade pivot.

8. The sharpener of claim 1, wherein the first multiplicity of cutting teeth and the second multiplicity of cutting teeth are configured to cooperate with one another for the purpose of forming the new cutting edge the first handle and the second handle are squeezed toward one another.

9. (canceled)

10. A sawblade sharpener for forming a new cutting edge on an oscillating multi-tool sawblade, the sharpener comprising:
a first blade including a first multiplicity of cutting teeth;
a second blade including a second multiplicity of cutting teeth and pivotally coupled with the first blade;
a vertical portion for supporting the first blade;
a base portion for supporting the second blade;
a lever coupled with the vertical portion for engaging the first multiplicity of cutting teeth with the second multiplicity of cutting teeth so as to form the new cutting edge; and
a mechanism for supporting the oscillating multi-tool sawblade between the first blade and the second blade.

11. The sharpener of claim 10, wherein the first multiplicity of cutting teeth and the second multiplicity of cutting teeth have a size and configuration suitable for forming the new cutting edge.

12. The sharpener of claim 11, wherein the configuration comprises a zigzag shape.

13. The sharpener of claim 12, wherein the size is suitable for forming any of course cutting teeth, medium cutting teeth, fine cutting teeth, or very fine cutting teeth.

14. The sharpener of claim 10, wherein the base portion is configured to be coupled with a horizontal surface such as tabletop or a workbench.

15. The sharpener of claim 10, wherein a forcible lever couples the first blade with the lever, such that a downward force is transmitted to the first blade when the lever is rotated relative to the vertical portion.

16. A method for sharpening an oscillating multi-tool sawblade by way of a sawblade sharpener, comprising:
supporting the oscillating multi-tool sawblade between a first blade and a second blade;
causing the first blade to move toward the second blade; and
shearing off a dulled cutting edge of the oscillating multi-tool sawblade.

17. The method of claim 16, wherein the supporting comprises using a magnet to support the oscillating multi-tool sawblade such that the dulled cutting edge is disposed between the first blade and the second blade.

18. The method of claim 16, wherein causing the first blade to move comprises using a lever to engage a first multiplicity of cutting teeth comprising the first blade with a second multiplicity of cutting teeth comprising the second blade.

19. The method of claim 18, wherein shearing off the dulled cutting edge includes forming a new cutting edge.

20. The method of claim 19, wherein forming the new cutting edge includes cutting the oscillating multi-tool sawblade by way of the first multiplicity of cutting teeth and the second multiplicity of cutting teeth.
